(19) United States
(12) Patent Application Publication
(10) Pub. No.: US 2025/0211936 A1
(43) Pub. Date: Jun. 26, 2025

(54) SYSTEMS AND METHODS FOR CUSTOMER IMPRESSION IDENTIFICATION

(71) Applicant: Verizon Patent and Licensing Inc., Basking Ridge, NJ (US)

(72) Inventors: Howard Mizes, Salem, SC (US); Kaiss K. Alahmady, Plano, TX (US); Daniel J. Abreu, San Jose, CA (US); Basavaraj S. Patil, Concord, NC (US)

(21) Appl. No.: 18/394,064

(22) Filed: Dec. 22, 2023

(51) Int. Cl. H04W 4/021; H04W 4/02

(52) U.S. Cl. CPC H04W 4/021; H04W 4/026

(57) ABSTRACT

One or more systems and/or methods are provided for identifying one or more target roads of a point of interest (POI) and/or identifying impressions of the POI. In an example, a first target road of a POI may be identified, wherein the POI is viewable from the first target road. A plurality of locations of a User Equipment (UE) may be determined. A set of locations, of the plurality of locations, that are within a threshold distance of a road object corresponding to the first target road may be identified. It may be determined that the UE is associated with the impression based upon the set of locations meeting a threshold amount of locations.

### BACKGROUND

Impressions may be identified through location mapping and tracking, which may involve leveraging available geolocation data of a user to analyze consumer behavior and/or tailor experiences accordingly. For example, the geolocation data may be leveraged to gain insights into the places users visit, their dwell times, the paths they take, etc., which may be used for personalized content delivery, targeted advertising, and/or refining customer service and/or marketing strategies.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a diagram illustrating a representation of a data structure comprising road objects and/or a location of a roadside point of interest (POI) in accordance with an embodiment.

FIG. 1B is a diagram illustrating an example representation of a bounding box process in accordance with an embodiment.

FIG. 1C is a diagram illustrating determination of an angle of an orientation of a road object relative to a bearing of a POI in accordance with an embodiment.

FIG. 2 is a flow chart illustrating an example method for identifying one or more target roads of a POI in accordance with an embodiment.

FIG. 3 is a flow chart illustrating an example method for identifying one or more target roads of a POI in accordance with an embodiment.

FIG. 4A is a diagram illustrating determining a location of a User Equipment (UE) in accordance with an embodiment.

FIG. 4B is a diagram illustrating an example representation of a data structure comprising a target road object, a POI location and/or locations of a UE in accordance with an embodiment.

FIG. 5 is a flow chart illustrating an example method for identifying potentially viewable UEs in accordance with an embodiment.

FIG. 6 is a flow chart illustrating an example method for determining impression metrics of a POI in accordance with an embodiment.

FIG. 7 illustrates an exemplary data structure of a ping sequence of a UE in accordance with an embodiment.

FIG. 8 illustrates a representation of a ping sequence of a UE in accordance with an embodiment.

FIG. 9 illustrates an exemplary data structure showing a direction of travel of a UE in accordance with an embodiment.

FIG. 10 illustrates a representation of a ping sequence of a UE in accordance with an embodiment.

FIG. 11 illustrates an exemplary data structure showing a direction of travel of a UE in accordance with an embodiment.

FIG. 12 illustrates a representation of a ping sequence of a UE in accordance with an embodiment.

FIG. 13 illustrates an exemplary data structure showing a direction of travel of a UE in accordance with an embodiment.

FIG. 14 is an illustration of a scenario featuring an example non-transitory machine-readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

The following provides a discussion of some types of scenarios in which the disclosed subject matter may be utilized and/or implemented.

In the present disclosure, the term “road” may refer to at least one of an interstate, a highway, a street, a parkway, a pathway, a bikepath, a trail, a pedestrian walkway, etc.

In the present disclosure, the term “point of interest (POI)” may refer to at least one of a structure (e.g., advertising structure) displaying a visual object (e.g., an advertisement, a sign, a painting, a poster, a mural, and/or other type of content item). A POI may comprise a roadside POI, such as a billboard, an attraction, a building, etc. viewable from a road. The roadside POI, for example, may comprise a non-electronic display and/or an electronic display. The roadside POI (e.g., the billboard) may display a single content item or multiple content items (separately at different times and/or concurrently on separate sections of the roadside POI, for example). A POI (e.g., the roadside POI) may comprise a visual object (e.g., an advertisement, a sign, a painting, a poster, a mural, and/or other type of content item) displayed on (e.g., mounted to and/or printed on) an existing structure (e.g., a side of a building, a bridge, etc.).

In the present disclosure, the term “target road” (of a POI, for example) may refer to a road (i) from which the POI is viewable and/or (ii) that is targeted by the POI. For example, the POI may face a direction (e.g., a bearing of the POI) such that the POI is viewable (and/or clearly viewable) by users traveling on the target road.

One or more computing devices and/or techniques for identifying one or more target roads of a POI and/or impressions (e.g., customer impressions) of the POI are provided. Some existing systems may attempt to identify impressions by simply identifying users whose approximated locations are within a viewshed of the POI (e.g., a defined area from which the POI can be seen). However, such systems may (i) not be able to count impressions of users whose approximated locations are outside the viewshed but who in actuality traveled through the viewshed and/or viewed the POI, and/or (ii) may count impressions of users whose estimated locations are within the viewshed, but who are in a stationary location but not viewing the POI, not traveling on the target road, and/or in a (nearby) region outside the viewshed. The inaccuracy of such systems may be due, at least in part, to a level of accuracy of location data (e.g., ping-based location data) available for at least some User Equipments (UEs) not being accurate enough to accurately assign users to the viewshed. Some types of geolocation data (e.g., Global Positioning System (GPS) data) may provide geolocations that may be accurate enough to assign a user to the viewshed, but such types of geolocation data may be unavailable for a significant amount of users (e.g., such geolocation data may be limited to users in a subset of areas). The present disclosure provides techniques for an impression identification system to automatically identify and/or track impressions in an accurate manner (taking the level of accuracy of the location data into account, for example) and/or partitioning users associated with the impressions into user categories, which may be used for (i) selecting prospective POI locations from a set of candidate POI locations for constructing new POIs (e.g., constructing new billboards at the prospective POI locations), (ii) determining pricing of an existing POI (e.g., determining prices for renting an existing billboard based upon a measure of impressions associated with the existing billboard), and/or (iii) selecting content to display on a POI based on user categories of users that pass the POI, etc. Alternatively and/or additionally, techniques provided herein may be used to automatically identify one or more target roads of a POI, which may be used as an input by the impression identification system to identify and/or track impressions of the POI.

In some examples, location estimates determined using communication parameters of communication between a UE and one or more wireless communication sites (e.g., base stations, cell towers, etc.) may not be accurate enough to accurately assign the UE to a viewshed of a POI (e.g., a location estimate may indicate that the UE is within the viewshed while the UE is in actuality outside the viewshed in a different area, and a location estimate of a second UE may show that the second UE is outside the viewshed while the second UE is actually within the viewshed). However, one or more of the techniques of the present disclosure may enable usage of the location estimates to accurately determine whether the UE is associated with an impression of the POI. Thus, the present disclosure may provide for identifying proper impressions of the POI with increased accuracy, which may be technically advantageous as a result of capturing impressions of the POI in which the POI was actually viewable by passing users and/or not capturing impressions of users that were not exposed to the POI (e.g., users traveling in a different direction, users stationary in the vicinity of the POI, etc.) that would otherwise be included using existing techniques such as mapping locations to a viewshed.

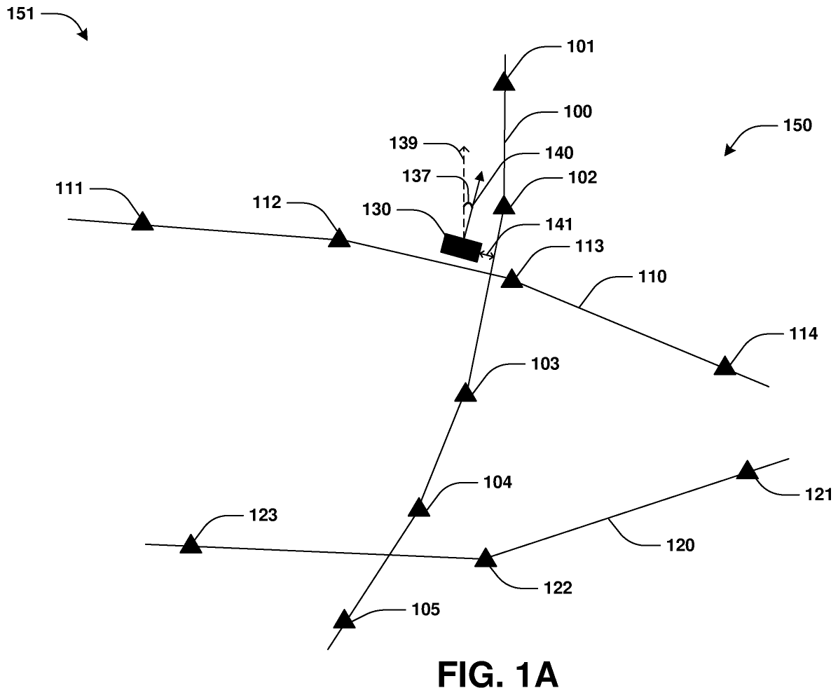

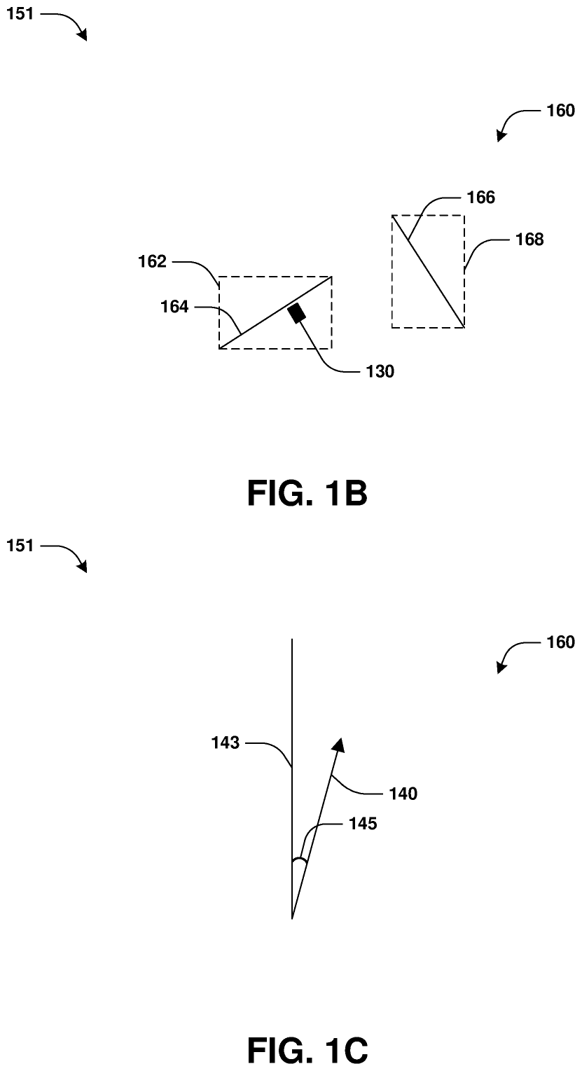

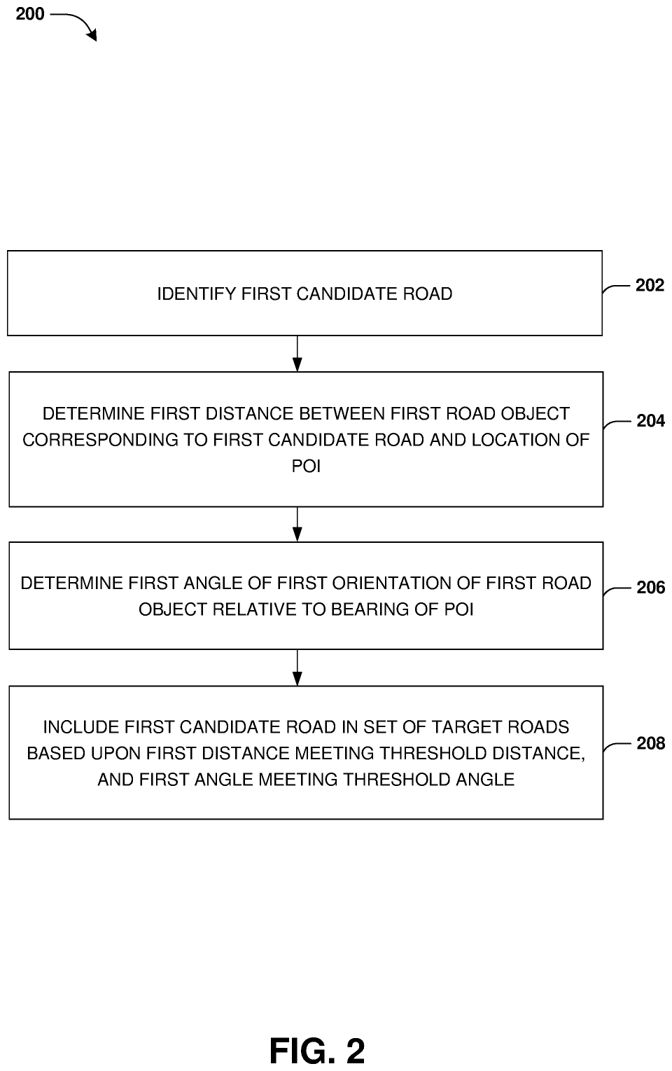

FIGS. 1A-1C illustrate an example of a system 151 for determining a set of target roads (e.g., a set of one or more target roads) of a POI, and is further described in conjunction with an example method 200 of FIG. 2. FIG. 1A illustrates a representation 150 of a data structure comprising a first road object 100 associated with a first road, a second road object 110 associated with a second road and/or a third road object 120 associated with a third road. A road object may comprise location points (shown as triangles in FIG. 1A) identifying locations of various points of a road. For example, a location point (e.g., geographic point) of a road object may correspond to a set of coordinates (e.g., a pair of coordinates) comprising a longitude coordinate and a latitude coordinate. In some examples, location points of a road object may be ordered, wherein lines (e.g., line segments) connecting adjacent location points of the road object may represent a road. In some examples, the first road object 100 comprises a first linestring comprising (i) location points 101, 102, 103, 104 and 105 and/or (ii) lines (e.g., line segments) between the location points. The second road object 110 may comprise a second linestring comprising (i) location points 111, 112, 113 and 114 and/or (ii) lines (e.g., line segments) between the location points. The third road object 120 may comprise a third linestring comprising (i) location points 121, 122 and 123 and/or (ii) lines (e.g., line segments) between the location points. The data structure may comprise identifying information associated with a road object (e.g., the first road object 100, the second road object 110, and/or the third road object 120), such as the name of a road corresponding to the road object and/or a type of the road (e.g., interstate, parkway, etc.). In some examples, a density of location points of a road object is greater than a threshold to account for bends and/or curves of a road (e.g., a curvature in the road between adjacent location points of the road object may be negligible). Embodiments are contemplated in which a road object (e.g., the first road object 100, the second road object 110, and/or the third road object 120) comprises an object other than (and/or in addition to) a linestring, such as at least one of a polygon, a multi-linestring, etc. The data structure may comprise a POI location 130 of the POI, a bearing 137 of the POI and/or a bearing vector 140 extending from the POI location 130 in a direction corresponding to the bearing. The bearing 137 may be indicative of a direction in which the POI faces with respect to a reference direction 139 (e.g., north direction or other reference direction). In an example, the bearing 137 of the POI corresponds to an angle between the direction in which the POI faces and the reference direction 139.

At 202 of FIG. 2, a target road identification system may identify a set of candidate roads (e.g., a set of one or more candidate roads) associated with the POI. The set of candidate roads may be a subset of a plurality of roads associated with road objects stored in a road dataset (e.g., a database of road objects comprising road objects and/or identifying information for some and/or all roads of a country, a state, and/or other geographical area). In some examples, a road may be selected from the plurality of roads for inclusion in the set of candidate roads based upon a determination that at least a portion of the road is in a same geographical area (e.g., city, county, zip code, etc.) as the POI location 130. For example, the road object data store may be indicative of geographical identification information (e.g., city, county, zip code, etc.) associated with at least some of the plurality of roads. The geographical identification information be used to select one or more roads for inclusion in the set of candidate roads based upon the one or more roads being in a matching geographical area as the POI location 130, such as based upon the one or more roads being at least partially within at least one of a city, county, zip code, etc. that matches at least one of a city, county, zip code, etc. of the POI location 130. In some examples, geographical information indicating at least one of city, county, zip code, etc. may not be available for at least some roads of the plurality of roads.

In some examples, for each road object of a plurality of road objects (e.g., at least some road objects stored in the road object data store), the target road identification system may perform a bounding box process, as shown in FIG. 1B, to determine whether to include a road corresponding to the road object in the set of candidate roads. The bounding box process may be performed for road objects for which geographical information (e.g., city, county, zip code, etc.) is not available. Alternatively and/or additionally, the target road identification system may identify a set of geographically related roads that are determined to at least partially be within the same geographical area (e.g., city, county, zip code, etc.) as the POI location 130. The target road identification system may perform the bounding box process on a road object of a road of the set of geographically related roads to determine whether to include the road in the set of candidate roads. Thus, performing the bounding box process may filter at least some of the set of geographically related roads from the set of candidate roads.

FIG. 1B illustrates a representation 160 of performing the bounding box process for a road object 164 and/or a road object 166. A first bounding box 162 may be generated based upon the road object 164. The first bounding box 162 may correspond to a rectangle comprising at least a portion of the road object 164. In an example, the first bounding box 162 may be a smallest possible rectangle that encompasses the road object 164 (e.g., a smallest possible rectangle that encompasses the entirety of the road object 164). In some examples, a road corresponding to the road object 164 may be included in the set of candidate roads based upon the POI location 130 being within the first bounding box 162. A second bounding box 168 may be generated based upon the road object 166. In some examples, the target road identification system may not include a road corresponding to the road object 166 in the set of candidate roads based upon the POI location 130 not being within the second bounding box 168.

Thus, in accordance with some embodiments, performing the bounding box process may reduce a quantity of the set of candidate roads (by filtering out and/or not including roads that do not have a bounding box encompassing the POI location 130, for example), which may provide for increased speed of (and/or reduced computations required for) determining the set of target roads of the POI.

Referring back to FIG. 1A, the set of candidate roads may comprise the first road corresponding to the first road object 100, the second road corresponding to the second road object 110 and/or the third road corresponding to the third road object 120. For example, the first road, the second road and/or the third road may be included in the set of candidate roads in response to determining (by performing the bounding box process, for example) that the first road, the second road and/or the third road are each associated with a bounding box that encompasses the POI location 130.

In some examples, for each candidate road of the set of candidate roads, the target road identification system may perform one or more first acts to determine whether the candidate road is a target road of the POI (and/or whether to include the candidate road in the set of target roads of the POI). For example, the one or more first acts comprise (i) determining a distance (e.g., closest separation distance) between a road object (corresponding to a road) and the POI location 130, (ii) determining an angle of an orientation of the road object relative to the bearing 137 (and/or the bearing vector 140), and/or (iii) determining whether to include the road in the set of target roads based upon (A) whether the distance meets a threshold distance and/or (B) whether the angle meets a threshold angle.

At 204 of FIG. 2, the target road identification system may determine a first distance between the first road object 100 and the POI location 130. The first distance may correspond to a closest separation distance between the first road object 100 and the POI location 130. Alternatively and/or additionally, the first distance may be determined by (i) identifying a closest location point, of the first road object 100, that is closest to the POI location 130 among location points of the first road object 100 (e.g., the closest location point may be determined to be location point 102 in FIG. 1A) and/or (ii) determining the first distance to be a distance between the closest location point (e.g., location point 102) and the POI location 130. Alternatively and/or additionally, the first distance may be determined by (i) identifying a pair of closest location points, of the first road object 100, that are closest to the POI location 130 among location points of the first road object 100 (e.g., the pair of closest location points may be determined to include location point 102 and location point 103 in FIG. 1A) and/or (ii) determining the first distance to be a distance 141 between the POI location 130 and a line segment connecting the pair of location points, wherein the distance 141 may be a closest separation distance between the line segment and the POI location 130.

At 206 of FIG. 2, the target road identification system may determine a first angle of a first orientation of the first road object 100 relative to the bearing 137 (and/or the bearing vector 140). The first orientation of the first road object 100 may correspond to a vector between a location point of closest approach on the first road object 100 and a next adjacent point in the first road object 100 oriented towards the bearing 137 (and/or the bearing vector 140). For example, the vector may be determined by (i) identifying the closest location point, of the first road object 100, that is closest to the POI location 130 among location points of the first road object 100 (e.g., the closest location point may be determined to be location point 102 in FIG. 1A) and/or (ii) identifying an adjacent location point (e.g., a location point that is adjacent the closest location point), in the first road object 100, oriented towards the bearing 137 (and/or the bearing vector 140). In an example, the adjacent location point may be determined to be location point 101 in FIG. 1A. In an example, the vector may extend through location point 102 and location point 101 (e.g., the vector may start from location point 102 and/or terminate at location point 101). FIG. 1C illustrates the vector (shown with reference number 143) corresponding to the first orientation of the first road object 100, the bearing vector 140, and/or the first angle (shown with reference number 145) corresponding to an angular difference between the vector 143 and the bearing vector 140.

At 208 of FIG. 2, the target road identification system may include the first road in the set of target roads based upon (i) the first distance meeting a first threshold distance and/or (ii) the first angle meeting a first threshold angle. For example, the first distance may meet the first threshold distance when the first distance is less than (and/or at most) the first threshold distance. The first threshold distance may be based upon a size of the POI, where a greater size of the POI (e.g., a size of a billboard) may correspond to a greater value of the first threshold distance (e.g., the POI being larger may allow the POI to be viewed from farther away). Alternatively, and/or additionally, the first threshold distance may be based upon a type of the POI, where the POI being a first type (e.g., a billboard comprising an electronic display that provides for improved readability) may correspond to a greater value of the first threshold distance than the POI being a second type (e.g., a billboard comprising a non-electronic visual object, such as a printed visual object), such as due, at least in part, to the first type providing for improved readability from a farther distance as compared with the second type. Alternatively, and/or additionally, the first threshold distance may be based upon one or more obstructions, such as at least one of trees, buildings, bridges, roads, etc. Alternatively and/or additionally, the first angle may meet the first threshold angle when the first angle is less than (and/or at most) the first threshold angle. The first threshold angle may correspond to a maximum angle between (i) a vector from the POI to a user on a road, and (ii) a vector normal to the POI (e.g., the bearing vector 140), wherein the POI is deemed viewable by the user. The first threshold angle may be between about 0 degrees to about 90 degrees, may be between about 30 degrees to about 70 degrees, and/or may be about 60 degrees (or other value and/or range).

In an example, the set of candidate roads may comprise more than one candidate road, and thus, may comprise one or more further candidate roads in addition to the first candidate road (e.g., the one or more further candidate roads may comprise the second road and/or the third candidate road). In some examples, for each candidate road of the one or more further candidate roads, the target road identification system may perform the one or more first acts to determine whether the candidate road is a target road of the POI (and/or whether to include the candidate road in the set of target roads of the POI). For example, the one or more first acts may be performed using one or more of the techniques provided herein with respect to determining whether to include the first road in the set of target roads.

In an example, the target road identification system may (i) determine a second distance (e.g., closest separation distance) between the second road object 110 and the POI location 130 (such as using one or more of the techniques provided herein with respect to determining the first distance), (ii) determine a second angle of a second orientation of the second road object 110 relative to the bearing 137 (such as using one or more of the techniques provided herein with respect to determining the first angle), and/or (iii) determine whether to include the second road in the set of target roads based upon (A) whether the second distance meets the first threshold distance and/or (B) whether the second angle meets the first threshold angle. The second distance may correspond to a distance between location point 113 of the second road object 110 and the POI location 130. The second angle may correspond to an angle between the bearing vector 140 and a vector (e.g., corresponding to the second orientation) that extends through location point 113 and location point 112 (e.g., the vector may start from location point 113 and/or terminate at location point 112). For example, while the second distance may meet (e.g., be less than and/or at most) the first threshold distance, the target road identification system may determine not to include the second road in the set of target roads based upon the second angle not meeting the first threshold angle (e.g., users traveling on the second road may not be able to view the POI clearly due to traveling in a direction that is about perpendicular to the bearing vector 140). Embodiments are contemplated in which the second angle is determined before determining a distance (e.g., the second distance) associated with the second road object 110, and the target road identification system does not determine the second distance in response to determining that the second road is not a target road of the POI based upon the second angle not meeting the first threshold angle.

In an example, the target road identification system may (i) determine a third distance (e.g., closest separation distance) between the third road object 120 and the POI location 130 (such as using one or more of the techniques provided herein with respect to determining the first distance), (ii) determine a third angle of a third orientation of the third road object 120 relative to the bearing 137 (such as using one or more of the techniques provided herein with respect to determining the first angle), and/or (iii) determine whether to include the third road in the set of target roads based upon (i) whether the third distance meets the first threshold distance and/or (ii) whether the third angle meets the first threshold angle. The third distance may correspond to a distance between location point 122 of the third road object 120 and the POI location 130. For example, the target road identification system may determine not to include the third road in the set of target roads based upon the third distance not meeting the first threshold distance. Embodiments are contemplated in which the third distance is determined before determining an angle (e.g., the third angle) associated with the third road object 120, and the target road identification system does not determine the third angle in response to determining that the third road is not a target road of the POI based upon the third distance not meeting the first threshold distance.

Embodiments are contemplated in which the target road identification system is configured to determine the set of target roads to include at most a threshold quantity of target roads k (e.g., only one target road, at most two target roads, etc.). For example, the target road identification system may identify (using the techniques provided herein, for example) a plurality of roads that are each associated with (A) a distance (e.g., closest separation distance) that meet the first threshold distance relative to the POI location 130 and/or (B) an orientation having an angle (relative to the bearing 137) that meets the first threshold angle. The target road identification system may rank the plurality of roads (based upon distance and/or angle, for example) and/or may select the top k ranked roads for inclusion in the set of target roads. The ranking of the roads is performed using a ranking criteria with ordering them either in ascending order by distance, angle, and/or a combination of distance and angle (e.g., a weighted sum of distance and angle). The threshold quantity of target roads may be one, two, ten, 100, or other value.

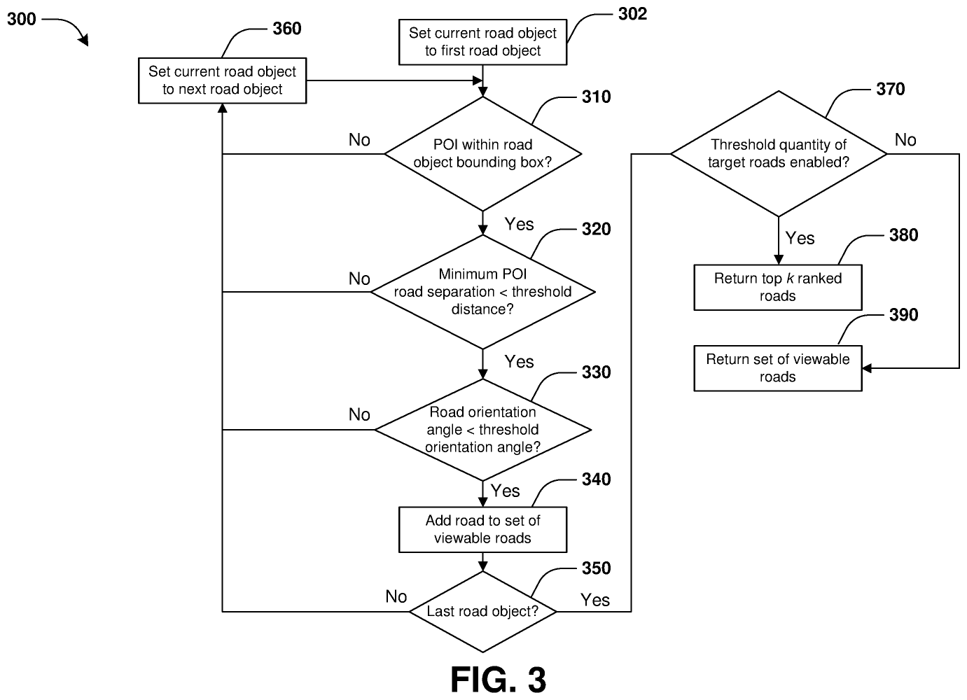

An embodiment of determining the set of target roads is illustrated by an exemplary method 300 of FIG. 3, described in conjunction with FIGS. 1A-1C. The target road identification system may be provided with an input comprising a plurality of road objects (from the road object data store, for example), the POI location 130 and/or the bearing 137 (and/or the bearing vector 140). The target road identification system may perform the exemplary method 300 using the input. At 302, the target road identification system may set a current road object to the first road object 100 of the plurality of road objects. Examples are contemplated in which the target road identification system sets the current road object to another road object of the plurality of road objects at 302. The target road identification system may perform one or more of acts 310, 320 and/or 330 to determine whether to include the current road object in a set of viewable roads.

At 310, the target road identification system may perform the bounding box process to (i) generate a bounding box associated with the current road object and/or (ii) determine whether the POI location 130 is within the bounding box. In some examples, if geographical identification information is available for the current road object, act 310 may include determining whether or not a geographical area (e.g., a city, county, zip code, etc.) of the current road object matches (e.g., overlaps with and/or is the same as) a geographical area of the POI location. The bounding box process may (or may not) be performed when the geographical identification information is available for the current road object. In response to determining (at 310) that the POI location 130 is within the bounding box (and/or that the geographical area of the current road object matches the geographical area of the POI location 130), the target road identification system may, at 320, determine whether a distance (e.g., the first distance) between the current road object and the POI location 130 meets the first threshold distance.

In response to determining (at 320) that the distance meets the first threshold distance, the target road identification system may, at 330, determine whether an angle (e.g., the first angle 145) of an orientation of the current road object relative to the bearing 137 meets the first threshold angle. In response to determining (at 330) that the angle meets the first threshold angle, the target road identification system may, at 340, determine to include the road (e.g., the first road) corresponding to the current road object in the set of viewable roads. Alternatively and/or additionally, the target road identification system may not include the current road object in the set of viewable roads (and/or may perform act 360 to set the current road object to a next road object, such as a road object of the plurality of road objects that has not yet been processed and/or analyzed to determine whether to include a corresponding road in the set of viewable roads) in response to (i) a determination (at 310) that the POI location 130 is not within the bounding box (and/or that the geographical area of the current road object does not match the geographical area of the POI location 130), (ii) a determination (at 320) that the distance does not meet the first threshold distance, and/or (iii) a determination (at 330) that the angle does not meet the first threshold angle.

In response to performing action 340, the target road identification system may determine, at 350, whether the current road object is a last road object of the plurality of road objects. In response to determining (at 350) that the current road object is not the last road object of the plurality of road objects (e.g., there are one or more remaining road objects, of the plurality of road objects, that have not yet been processed and/or analyzed to determine whether to include corresponding roads in the set of viewable roads of the POI), the target road identification system may, at 360, set the current road object to a next road object (e.g., a road object, such as any road object, of the one or more remaining road objects). In accordance with the exemplary method 300 of FIG. 3, for each of the one or more remaining road objects, the target road identification system may perform acts 310, 320, 330, and/or 340 to determine the set of viewable roads.

In some examples, in response to determining (at 350) that the current road object is the last road object of the plurality of road objects (e.g., all of the plurality of road objects have been processed and/or analyzed to determine whether to include corresponding roads in the set of viewable roads of the POI), the target road identification system may determine, at 370, whether the threshold quantity of target roads is enabled. If the threshold quantity of target roads is enabled, the target road identification system may output at most k roads, from the set of viewable roads, as the set of target roads at 380. For example, when a quantity of roads of the set of viewable roads exceeds the threshold quantity of target roads, the top k roads ranked according to the ranking criteria to the POI location 130 may be selected from the set of viewable roads for inclusion in the set of target roads. Alternatively, and/or additionally, when the quantity of roads of the set of viewable roads does not exceed the threshold quantity of target roads, all of the set of viewable roads may be included in the set of target roads. Alternatively, and/or additionally, when the threshold quantity of target roads is not enabled, all of the set of viewable roads may be included in the set of target roads and/or output by the target road identification system at 390. In accordance with some embodiments, acts (e.g., filtering acts) of the exemplary method 300 may be performed in any order, such as in an order different than shown in FIG. 3.

The target road identification system may provide the set of target roads of the POI to an impression identification system for use in identifying and/or tracking impressions associated with the POI. An impression may correspond to a view of the POI by a user and/or an opportunity to view the POI by the user. The user may correspond to an occupant of a vehicle traveling along a target road of the set of target roads (in a viewable direction of the POI, for example).

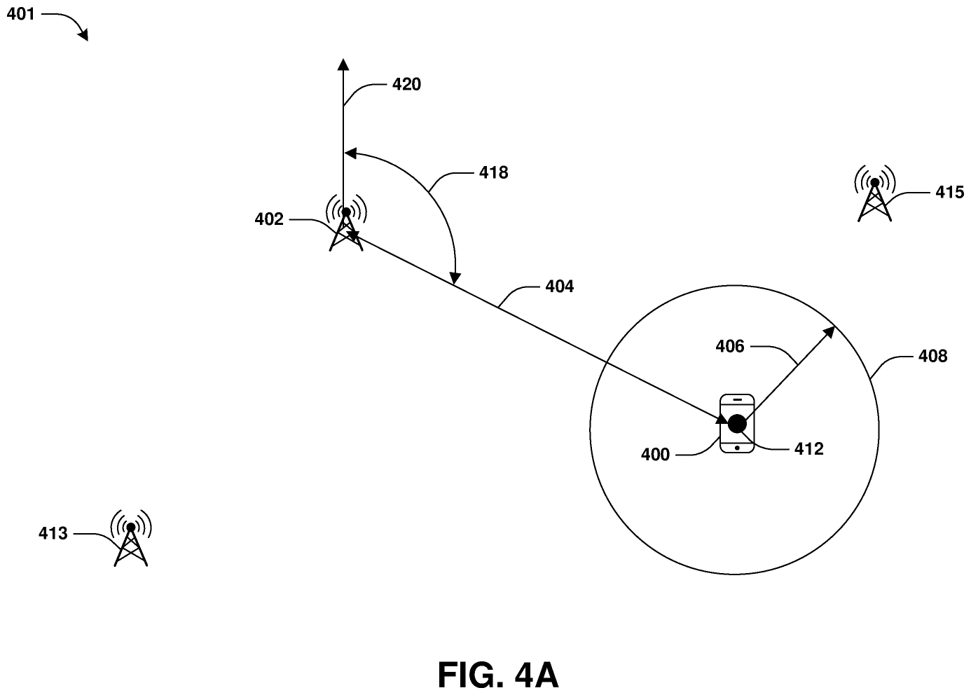

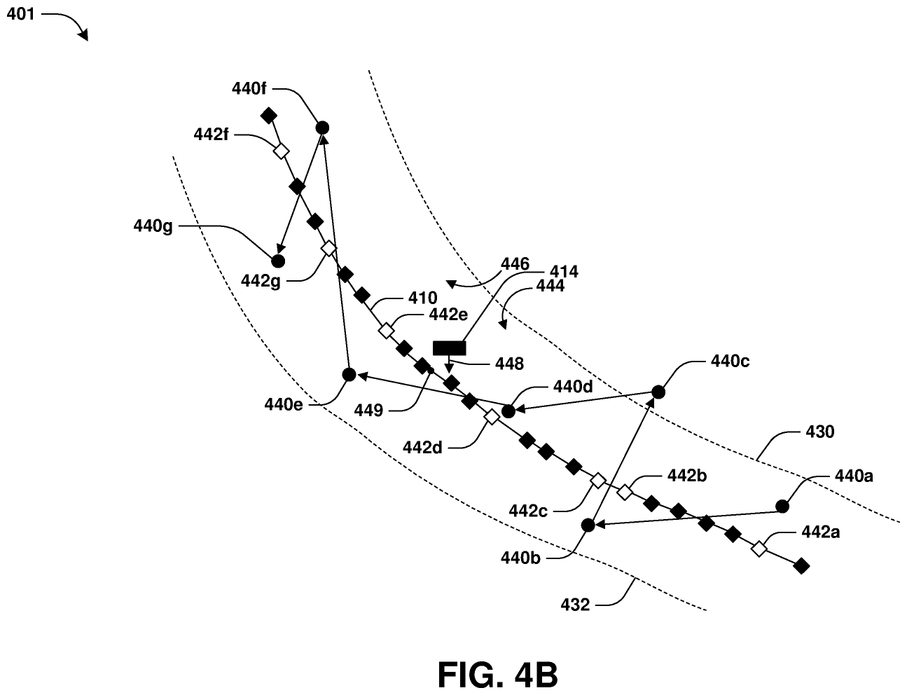

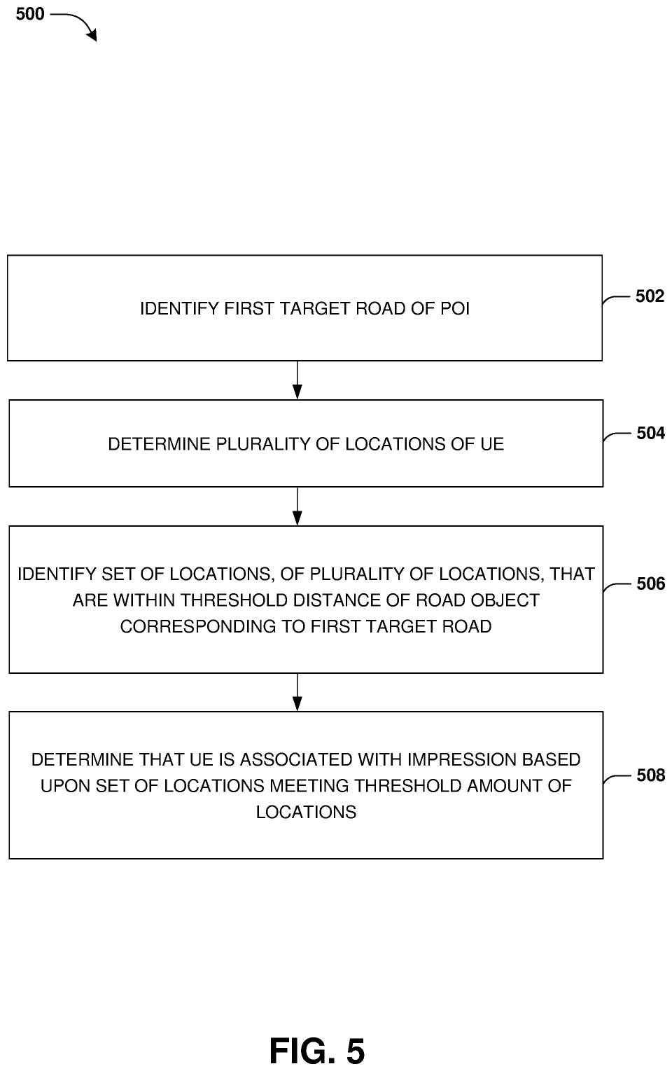

FIGS. 4A-4B illustrate an example of a system 401 for identifying an impression associated with a POI, and is further described in conjunction with an example method 500 of FIG. 5. FIG. 4A illustrates communication of a UE 400 with a wireless communication site 402. The UE 400 may comprise at least one of a phone (e.g., a smartphone), a vehicle communication device, a laptop, a computer, a wearable device, a smart device, a television, any other type of computing device, hardware and/or software. The wireless communication site 402 may comprise a base station, a cell tower, an antenna branch, an antenna tower, a transmission and/or reception point (TRP), etc. The communication of the UE 400 with the wireless communication site 402 may occur when at least one of (i) a call (e.g., a telephone call) is established using the UE 400, (ii) a message (e.g., a text message, an instant message, etc.) is sent by the UE 400, (iii) a network (e.g., a public network such as the Internet) is accessed using the UE 400, (iv) an application (e.g., a mobile application, a web application, etc.) of the UE 400 uploads and/or download data, (v) a passive communication of power levels and/or other network information indicates that a communication with the UE 400 should be made, and/or (vi) a cell handoff is made using the UE 400 (while a user of the UE 400 is traveling, for example). The wireless communication site 402 (and/or the impression identification system) may determine a distance 404 (e.g., a timing advance distance) based upon the communication. The communication may comprise a signal (e.g., a communication signal and/or a ping) transmitted by the UE 400 to the wireless communication site 402.

A timing advance associated with the signal and/or the UE 400 may be determined by the wireless communication site 402 (and/or the impression identification system). For example, the signal may comprise an indication of the timing advance. The timing advance may accommodate a communication lag (due to the time it takes for the signal to be transmitted from the UE 400 to the wireless communication site 402, for example). The timing advance (for the UE 400, for example) may be used to time the arrival of one or more signals from the UE 400 (transmitted to the wireless communication site 402, for example). Other timing advances for other devices may be used to time the arrival of signals from multiple devices in communication with a single communication site (e.g., the wireless communication site 402). The wireless communication site 402 (and/or the impression identification system) may determine (e.g., predict) the distance 404 based upon the timing advance.

Power levels of the UE may be received from the wireless communication site 402 and/or from neighboring sites 413 and 415. The power level may be used to identify an approximate angle 418 between the direction to the cell tower and a fixed direction 420. A first location 412 (shown as a black-filled circular point in FIG. 4A) of the UE 400 may be determined (e.g., approximated) based upon the distance 404 and/or the fourth angle (and/or the direction determined based upon the fourth angle) associated with the first receiver used to receive the signal. In some examples, one or more communication parameters associated with communication between the UE 400 and one or more wireless communication sites (e.g., wireless communication sites 402, 413 and/or 415) may be received. The one or more communication parameters may be used to determine the first location 412 (e.g., a first location estimate) and/or other locations of the UE 400. The one or more communication parameters may comprise at least one of a base station identifier, a cell identifier, a timing advance parameter, a signal strength parameter, a signal quality parameter, a power level, etc.

The first location 412 may be an approximation. Due to an uncertainty associated with the distance 404 and/or the angle (and/or direction) 418, there may be uncertainty in the first location. The first location 412 may have a first level of accuracy 406. For example, an actual location of the UE 400 may be within an uncertainty region 408 (e.g., a circle or other shape) having a radius corresponding to the first level of accuracy 406. The first level of accuracy 406 may be between about 100 meters to about 700 meters (or other value and/or range). The first level of accuracy 406 may depend upon one or more factors comprising a type of communication (e.g., 3G, 4G, 5G, etc.) between the UE 400 and the wireless communication site 402, one or more obstructions (e.g., at least one of trees, buildings, bridges, etc. between the UE 400 and the wireless communication site 402), and/or a concentration of communication sites in a geographical area of the UE 400 (e.g., there may be more communication sites in an urban area as compared with a rural area, which may provide for more accurate location estimates of the UE 400 if the UE 400 is in the urban area). The first location 412 may be determined via Global System for Mobile communication (GSM) localization. Embodiments are contemplated in which the first location 412 is determined via Global Positioning System (GPS) geolocation.

At 502 of FIG. 5, the impression identification system may identify a set of target roads (e.g., a set of one or more target roads) of a POI. For example, the set of target roads of the POI may be determined using one or more of the techniques provided herein with respect to FIGS. 1A-1C, 2 and/or 3. The target road identification system may provide the impression identification system with an indication of the set of target roads, a POI location 414 (shown in FIG. 4B) of the POI, a bearing of the POI (e.g., a direction in which the POI faces) and/or a bearing vector 448 extending in the direction of the bearing. The set of target roads may comprise a first target road corresponding to a first target road object 410 (shown in FIG. 4B). The set of target roads may comprise only the first target road, or may comprise one or more additional target roads in addition to the first target road.

At 504 of FIG. 5, the impression identification system may determine a plurality of locations of the UE 400. For example, the plurality of locations may comprise the first location 412 and other locations of the UE 400. In some examples, some and/or all of the plurality of locations are determined based upon signals received by the wireless communication site 402 (and/or one or more other wireless communication sites) from the UE 400, such as using one or more of the techniques provided herein with respect to determining the first location 412. The UE 400 may transmit signals (e.g., communication signals and/or pings) in a periodic manner (and/or an aperiodic manner) to the wireless communication site 402 (and/or one or more other wireless communication sites).

At 506 of FIG. 5, the impression identification system may identify a set of locations, of the plurality of locations (of the UE 400), that are within a second threshold distance of the first target road object 410 corresponding to the first target road. The second threshold distance may be based upon (e.g., may be about equal to and/or may be a function of) the first level of accuracy 406.

FIG. 4B illustrates a representation 150 of a data structure comprising the first target road object 410 associated with the first target road, the POI location 414 of the POI, and/or locations (shown as black-filled circular points 440a-g in FIG. 4B) of the plurality of locations of the UE 400. The first target road object 410 may comprise a linestring comprising (i) location points (shown as black-filled diamonds in FIG. 4B) and/or (ii) lines (e.g., line segments) between the location points.

The impression identification system may generate a set of road bounds of the first target road object 410 (based upon the second threshold distance, for example). The set of road bounds may comprise a first road bound 430 on a first side of the first target road object 410 and/or a second road bound 432 on a second side of the first target road object 410. In some examples, each of the set of road bounds is generated such that a closest distance between a point of the road bound (e.g., each point of the road bound) and the first target road object 410 is about equal to the second threshold distance.

In some examples, the uncertainty region 408 may have a shape that is more complex shape than the circle shown in FIG. 4A, and the set of road bounds may be generated to capture potential locations (e.g., a circle or other shape) having a radius corresponding to the first level of accuracy 406. For example, at least a first portion of a road bound (e.g., the first road bound 430 and/or the second road bound 432) may be closer to the first target road object 410 than the second threshold distance, and/or at least a second portion of the road bound may be more distant from the first target road object 410 than the second threshold distance. The set of road bounds may be generated to capture a region where most pings occur for a user traveling on the first target road. The set of road bounds may span a larger region for rural areas and/or a smaller region for urban areas (since wireless communication sites may be more densely populated in urban areas).

In an example, if the user of the UE 400 travels on the first target road, more of the plurality of locations will lie between the set of road bounds as opposed to a scenario in which the user travels on a different road in the vicinity of the first target road. Thus, in accordance with some embodiments, the impression identification system may be able to accurately determine whether the UE 400 is associated with an impression of the POI by determining whether a quantity of locations of the set of locations meets or exceeds a threshold amount of locations.

The plurality of locations may comprise locations 440a, 440b, 440c, 440d, 440e, 440f, 440g and/or other locations. FIG. 4B depicts arrows that are between locations of the plurality of locations and are representative of an ordered sequence of signals based upon which the locations are determined (e.g., location 440a is based upon a signal that is transmitted prior to a signal based upon which location 440b is determined). In some examples, locations that are between the set of road bounds are included in the set of road bounds. For example, with respect to FIG. 4B, the set of locations may be determined to include location 440a, location 440b, location 440d, location 440e, location 440f and/or location 440g. Location 440c may not be included in the set of locations based upon the location 440c being outside the set of road bounds.

At 508 of FIG. 5, the impression identification system may determine that the UE 400 is associated with a first impression based upon the set of locations meeting or exceeding the threshold amount of locations (and/or based upon one or more other conditions being met). The first impression may correspond to a view of the POI by the user of the UE 400 and/or an opportunity to view the POI by the user (while the user is traveling along the first target road of the POI, for example).

In some examples, the threshold amount of locations may correspond to a threshold proportion of the plurality of locations. The threshold amount of locations may be between about 30% to about 90% (or other value and/or range). In an example in which the threshold amount of locations is 70%, the set of locations may meet or exceed the threshold amount of locations when the set of locations make up at least 70% of the plurality of locations (e.g., at least 70% of the plurality of locations are within the second threshold distance of the first target road object 410). Alternatively and/or additionally, the threshold amount of locations may correspond to a threshold quantity of locations (e.g., a quantity between 3 and 100 locations, a quantity of 5 locations, a quantity of 10 locations, or other number of locations). In an example in which the threshold amount of locations is 5 locations, the set of locations may meet or exceed the threshold amount of locations when the set of locations comprises at least 5 locations.

Referring back to FIG. 4B, the impression identification system may map locations of the plurality of locations (e.g., some and/or all of the plurality of locations) to a set of road object locations (e.g., snap-to-road locations) along the first target road object 410. The set of road object locations are shown as white-filled diamonds in FIG. 4B). The impression identification system may map the locations (of the plurality of locations) to the set of road object locations in response to determining that the set of locations meets or exceeds the threshold amount of locations. In an example, the set of road object locations may comprise road object locations 442a, 442b, 442c, 442d, 442e, 442f, 442g and/or other road object locations. For example, locations 440a, 440b, 440c, 440d, 440e, 440f and/or 440g may be mapped to road object locations 442a, 442b, 442c, 442d, 442e, 442f and/or 442g, respectively. In an example, a road object location of the set of road object locations may correspond to a location, along the first target road object 410, that is closest to a corresponding location of the plurality of locations (e.g., road object location 442a may be a closest point along the first target road object 410 to location 440a).

A “distance along road” may be defined as a distance between a point 449 (e.g., a fixed point) on the first target road object 410 and a road object location of the set of road object locations. The distance along road can take on either negative or positive values (and/or zero). The closest point (e.g., the point 449) between the POI and the first target road object 410 may partition the first target road (and/or the first target road object 410) into two portions comprising a first portion 444 associated with negative values and a second portion 446 associated with positive values. The first portion 444 is on a first side of the point 449 and the second portion 446 is on a second side of the point 449. The first portion 444 (that the POI faces, for example) may be defined to be associated with negative values and/or the second portion 446 may be defined to be associated with positive values. For example, road object locations 442a-d may have negative distance along road values and road object locations 442e-g may have positive distance along road values. A set of distance along road values of the UE 400 may be determined. The set of distance along road values may comprise at least one of (i) a negative distance along road value corresponding to a distance between road object location 442a and the point 449, (ii) a negative distance along road value corresponding to a distance between road object location 442b and the point 449, (iii) a positive distance along road value corresponding to a distance between road object location 442e and the point 449, (iv) a positive distance along road value corresponding to a distance between road object location 442f and the point 449, etc.

In some examples, the impression identification system may determine a first direction of travel of the UE 400 based upon the plurality of locations (and/or the set of road object locations). towards the front of the POI or away from the back of the POI). In response to a determination that the distance along road is decreasing as a function of ping sequence or time, the impression identification system may determine that the user is traveling (in a nonviewable direction, for example) towards the back of the POI or away from the front of the POI.

Another approach to determine the direction of travel may be to calculate the relative angle between the bearing vector 448 and a vector oriented from the POI to snap to road positions 442a-442g. The impression identification system may determine that the UE is traveling past the POI in the viewable direction based upon the relative angle transitioning from an angle less than 90 degrees to an angle greater than 90 degrees. The impression identification system may determine that the UE is not traveling in the viewable direction past the POI (e.g., the UE may be traveling past the POI in a nonviewable direction) based upon the relative angle transitioning from an angle greater than 90 degrees to an angle less than 90 degrees. The transition point may be found by setting a threshold at 90 degrees and/or using other changepoint detection algorithms. The direction can be found by averaging the bearing for road object locations (e.g., snap to road positions, such as all snap to road positions) within the set of road bounds previous to the changepoint and following the changepoint.

In some examples, due to inaccuracies of the plurality of locations, mapping at least some of the plurality of locations to the set of road object locations may appear to reverse direction of the first direction of travel of the UE 400. For example, a signal used to determine location 440f and/or road object location 442f is received earlier than a signal used to determine location 440g and/or road object location 442g. However, an overall trend of the plurality of locations and/or the set of road object locations may indicate movement in the first direction of travel (e.g., the viewable direction of the POI).

In some examples, the first target road object 410 comprises (i) the first portion 444 corresponding to a first portion of the first target road on a first side of the POI and/or the point 449 and (ii) the second portion 446 corresponding to a second portion of the first target road on a second side of the POI and/or the point 449. In some examples, the impression identification system may determine that the UE 400 is associated with the first impression based upon the set of road object locations comprising (i) one or more first road object locations (e.g., 442a, 442b, 442c and/or 442d) in the first portion 444 of the first target road object 410, and (ii) one or more second road object locations (e.g., 442e, 442f and/or 442g) in the second portion 446 of the first target road object 410, which may indicate that a travel path of the UE 400 spans the POI (e.g., the UE 400 passed by the POI).

In some examples, the impression identification system may determine, based upon the plurality of locations (and/or the set of road object locations), a first distance of travel of the UE 400 along the first target road. The impression identification system may determine that the UE 400 is associated with the first impression based upon the first distance of travel meeting (e.g., being greater than and/or at least) a third threshold distance, which may indicate that the UE 400 is traveling on the first target road and/or is not stationary. In some examples, the third threshold distance is greater than the first level of accuracy 406, such as due, at least in part, to there being a possibility that the UE 400 does not provide a signal (e.g., a communication signal that can be used to derive a location of the plurality of locations) when the UE 400 is near (e.g., within a threshold distance of) the POI. In some examples, the first distance of travel of the UE 400 corresponds to a distance in which the UE 400 travels within the set of road bounds. The third threshold distance may be between about 500 meters to about 30 kilometers, and/or may be about 5 kilometers and/or about 15 kilometers (or other value and/or range).

In some examples, the impression identification system may determine, based upon the plurality of locations (and/or the set of road object locations), a first movement range of the UE 400. The first movement range may correspond to a difference between a first maximum distance of the UE 400 from the POI and a first minimum distance of the UE 400 from the POI within a time period (having a defined duration, for example). The first movement range may be determined based upon the plurality of locations (and/or the set of road object locations), such as locations within the set of road bounds. The impression identification system may determine that the UE 400 is associated with the first impression based upon the first movement range meeting (e.g., being greater than and/or at least) a threshold movement range, which may indicate that the UE 400 is traveling on the first target road and/or is not stationary. The threshold movement range may be between about 500 meters to about 10 kilometers, and/or may be about 5 kilometers (or other value and/or range).

In some examples, techniques provided herein may be used for analyzing location data of a plurality of devices and/or identifying impressions of the POI based upon the location data (e.g., location estimates of subscribers of a telecommunication service provider), such as using one or more of the techniques provided herein with respect to determining whether the UE 400 is associated with the impression of the POI.

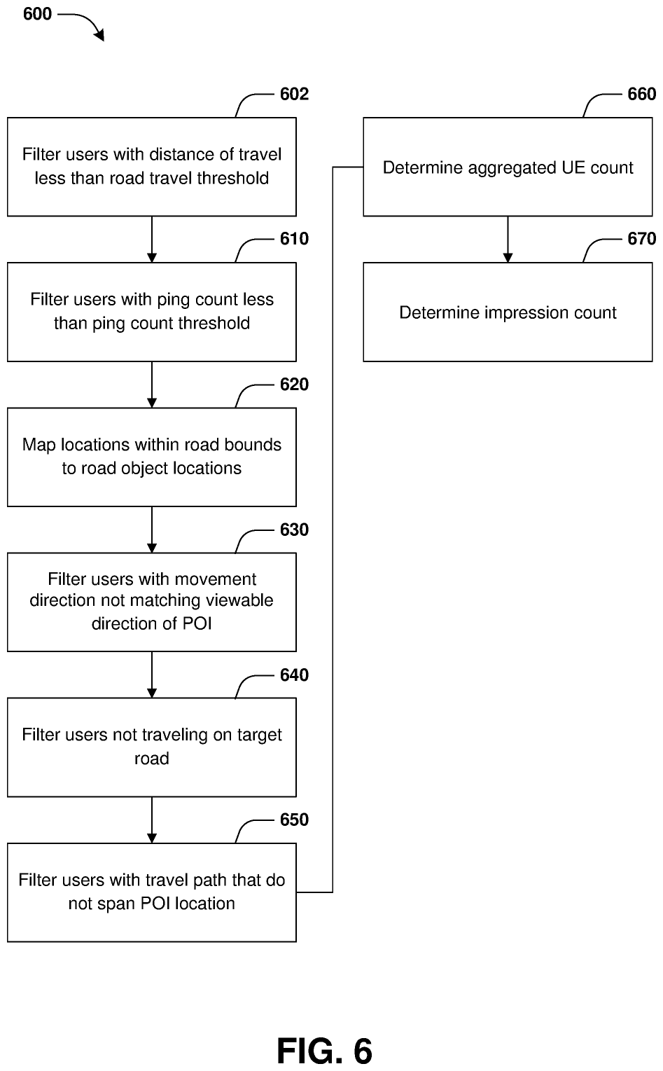

An embodiment of identifying users associated with impressions of the POI by an exemplary method 600 of FIG. 6, described in conjunction with FIGS. 4A-4B. The impression identification system may be provided with an input comprising location data associated with a plurality of UEs, the POI location 414, the bearing and/or bearing vector 448 of the POI and/or the set of target roads of the POI, which may include the first target road corresponding to the first target road object 410. The location data may comprise locations of the plurality of UEs (e.g., a set of locations for each UE), which may be determined based upon signals (e.g., communication signals and/or pings) using one or more of the techniques provided herein with respect to determining the first location 412 and/or using other techniques. In some examples, the plurality of UEs may be identified by one or more identifiers such as at least one of International Mobile Equipment Identity (IMEI), telephone number, or other type of identifier. The impression identification system may perform the exemplary method 600 using the input. The location data may comprise locations of the plurality of UEs derived from signals transmitted by the plurality of UEs throughout the course of a first period of time, such as one or more hours, one day, two days, a week, or other period of time. In some examples, the exemplary method 600 may be performed by the impression identification system to determine a number of impressions associated with the POI during the first period of time.

At 602, the impression identification system may filter a first set of client devices from the plurality of UEs to determine a second plurality of UEs (e.g., a subset of the plurality of UEs that does not include the first set of UEs). The second plurality of UEs may comprise UEs that have the potential to be traveling on the first target road. In some examples, if at least some signals received from the plurality of UEs include geographical information, signals that are indicative of a geographical area (e.g., city, county, zip code, etc.) matching a geographical area of the POI location 414 may be considered and/or signals that are indicative of a geographical area that does not match the geographical area of the POI location 414 may not be considered. Alternatively, and/or additionally, the first set of UEs may comprise UEs associated with signals that are indicative of a geographical area that does not match the geographical area of the POI location 414. Alternatively, and/or additionally, the first set of UEs may comprise UEs associated with distances of travel (determined using one or more of the techniques provided herein with respect to determining the first distance of travel, for example) that do not meet the third threshold distance.

At 610, the impression identification system may filter a second set of UEs from the second plurality of UEs to determine a third plurality of UEs (e.g., a subset of the second plurality of UEs that does not include the second set of UEs). A UE traveling along the first target road may have multiple pings as cell tower handoffs occur (e.g., each of the pings may correspond to a communication event in which a UE transmits a signal to a wireless communication site that can use the signal to determine a location). UEs with a ping count within the set of road bounds less than a ping count threshold may be included in the second set of UEs (such as due, at least in part, to the UEs being unlikely to be traveling along the first target road). The ping count threshold may be set to a value (e.g., a value between about 3 to about 100, such as 10). The ping count threshold may lie within a latitude window with the lower bound large enough to exclude UEs traveling on a different road and a higher bound small enough to include, in the third plurality of UEs, UEs that enter the first target road at an intersection near the POI, travel past the POI and then exit the first target road, for example. The ping count threshold may be determined based upon at least one of average road speed of a UE, a quantity of pings recorded when the UE is working actively or passively, speed of the user client (with different vehicles of transportation and/or traffic conditions, for example), etc.

At 620, the impression identification system may map locations of the third plurality of UEs to road object locations (using snap to road technique, for example). The locations mapped to the road object locations may comprise locations within the set of road bounds.

At 630, the impression identification system may filter a third set of UEs from the third plurality of UEs to determine a fourth plurality of UEs (e.g., a subset of the third plurality of UEs that does not include the third set of UEs). In some examples, directions of travel of the third plurality of UEs may be determined (using one or more of the techniques provided herein with respect to determining the first direction of travel, for example). The third set of UEs may comprise UEs associated with directions of travel different than (e.g., opposite to) the viewable direction associated with viewing the POI. The fourth plurality of UEs may comprise UEs associated with directions of travel matching the viewable direction associated with viewing the POI.

At 640, the impression identification system may filter a fourth set of client devices from the fourth plurality of UEs to determine a fifth plurality of UEs (e.g., a subset of the fourth plurality of UEs that does not include the fourth set of UEs). For example, the fourth set of UEs may comprise UEs that are determined to be stationary and/or UEs moving in a region outside the first target road (e.g., the region may comprise a residence, a point of interest (POI), a store, a park, an airport, a labeled location, etc.). At least some of the fourth set of UEs may communicate multiple times with one or more wireless communication sites, while some and/or all locations (e.g., position estimates) of the UEs may be within an uncertainty region (e.g., the uncertainty region 408). A moving UE, however, may be associated with locations (e.g., ping-based locations, such as the first location 412) that are within the set of road bounds and that cover a larger distance as compared with the fourth set of UEs. In some examples, movement ranges of the fourth plurality of UEs may be determined (using one or more of the techniques provided herein with respect to determining the first movement range, for example). The fourth set of UEs may comprise UEs associated with movement ranges that do not meet (e.g., are not greater than) the threshold movement range, thereby filtering stationary UEs and/or UEs that are not traveling on the first target road.

At 650, the impression identification system may filter a fifth set of UEs from the fifth plurality of UEs to determine a sixth plurality of UEs (e.g., a subset of the fifth plurality of UEs that does not include the fifth set of UEs). In some examples, the fifth set of UEs may comprise UEs associated with travel paths that do not span the POI location 414. For example, act 650 may filter UEs that traveled on the first target road in the direction of the POI but traveled away from the POI location 414 (by entering the first target road past the POI location 414 and/or taking an exit before the POI location 414, for example). The impression identification system may determine that the travel path of the UE spans the POI based upon a distance along road of the UE (e.g., the set of distance along road values associated with the UE 400) transitioning from a negative value to a positive value.

At 660, the impression identification system may determine an aggregated UE count (e.g., a user count). The aggregated UE count may correspond to a quantity of UEs of a set of remaining UEs (e.g., the second plurality of UEs) after performing filtering acts of exemplary method 600. The aggregated UE count may correspond to a service provider count associated with a telecommunication service provider (e.g., a count of impressions among subscribers of the telecommunication service provider over the first period of time). The service provider count may be extrapolated to a full population count (accounting for other clients subscribed to other service providers, for example), which may be determined at 670. For example, the service provider count may be combined with (e.g., divided by) a fractional market share of the telecommunication service provider to determine the full population count (e.g., a total count of impressions over the first period of time).

In accordance with some embodiments, acts (e.g., filtering acts) of the exemplary method 600 may be performed in any order, such as in an order different than shown in FIG. 6.

In some examples, the impression identification system may perform an impression metric tracking process (comprising one or more acts of the exemplary method 600, for example) at regular and/or irregular time intervals (e.g., hourly, daily, and/or other intervals) to determine one or more impression metrics (e.g., service provider count, full population count, etc.) and/or may generate a first report indicating (i) impression metrics associated with the POI for one or more periods of time, (ii) aggregated impression metrics (e.g., an average amount of impressions of the POI per unit of time, etc.). The impression identification system may provide the first report to a UE to be displayed. An example data structure (which may be included in the first report, for example) of a daily aggregation for a market share 33% for 3 days is shown in Table 1 for a single POI.

TABLE 1

| | Telecom customer | |
|---|---|---|
| Date | impressions | Total impressions |
| Aug. 1, 2023 | 20,000 | 60,000 |
| Aug. 2, 2023 | 15,000 | 45,000 |
| Aug. 3, 2023 | 25,000 | 75,000 |

In some examples, the impression identification system may determine (at act 508 of FIG. 5, for example) that the UE 400 is associated with the first impression based upon a determination that one, some and/or all of the following conditions are met: (i) the set of locations meets or exceeds the threshold amount of locations, (ii) the first distance of travel meets the third threshold distance, (iii) the first movement range meets the threshold movement range, (iv) the first direction of travel matches the viewable direction of the POI, (v) a travel path of the UE 400 spans the POI location 414, (vi) the UE 400 is not stationary, (vii) a ping count of the UE 400 is greater than the threshold ping count, and/or (viii) one or more other conditions.

In some examples, the UE 400 (and/or a user of the UE 400) may be labeled with a user type based upon location data associated with the UE 400 (and/or other information). A user type “commuter” may be defined as a user who travels one way on the road as they travel between their residence and their work location, and then travels the other way on the road as they return home. A commuter may be identified in a single day's aggregation by a sequence of pings where the distance along road versus the timestamp is positive over a first time interval and then the distance along road versus the timestamp is negative over a second time interval that occurs during the same day, such as early morning and late afternoon. Alternatively, and/or additionally, commuters may be identified by identifying users that travel on the road multiple times (e.g., at least a threshold number of times) in some interval of days (and/or other time period), such as 5 times or more in a week.

A user type “traveler” may be defined as a user who travels on the road in one direction only and was not observed traveling the road on previous days. For example, a user who was observed traveling on the road on the current day but was not observed traveling on the road for the previous week may be labeled as a traveler.

A user type “local” may be defined as a user that travels past the POI and has pings (e.g., transmissions of communication signals) that have been observed within a threshold local location distance such as 10 miles from the POI for a large quantity of previous days (e.g., at least a first threshold quantity of previous days). The threshold local location distance may be population density dependent, being larger for rural areas and/or smaller for urban areas. A user that has been observed within the threshold local location distance for at least a threshold proportion of previous days (e.g., 25 of the previous 30 days) may be labeled as a local. The threshold local location distance may be between about 1 mile to about 20 miles and/or may be about 10 miles (or other value and/or range).

A user type “visitor” may be defined as a user that travels past the POI and has pings that have been observed within some local location distance for a small number of previous days (e.g., less than the first threshold quantity of previous days). A user that has been observed with 10 miles for 3 (or other quantity) of the previous 30 days may be labeled as a visitor.

A user type “conversion” may be defined as a user that receives an impression of the POI and, after the impression, is located (a short time later, for example) at a location the POI is advertising. For example, when the POI is advertising a casino and the user pings occur in the vicinity of the casino at a time after the user passes the POI, then the user is labeled as a conversion. A visit to the casino may be identified based upon a determination that there are user pings within a distance (e.g., the first level of accuracy 406) of the casino and the time difference between the last user ping and the first user ping exceeds a visit threshold. The visit threshold may be between about 5 minutes to about 60 minutes, and/or may be about 30 minutes (or other value and/or range). There may be some users who intentionally intended to travel to the advertised location. Similar to the situation that a potential impression may not actually have occurred as the user passes by the POI, data driven analysis and/or heuristics may be applied to capture the users (to be labeled as conversions, for example) that were influenced by the POI. Such an example would be to include behavioral attributes such as websites visited, for example if the websites have to do with the advertised location. U.S. Non-Provisional patent application Ser. No. 18/537,377, filed on Dec. 13, 2023, entitled “SYSTEMS AND METHODS FOR ASSIGNING USER DEVICE MOVEMENT STATES,” is incorporated herein by reference in its entirety. In some examples, one, some and/or all of the techniques provided in U.S. Non-Provisional patent application Ser. No. 18/537,377 may be used for determining whether a user visited a location (e.g., the casino) and/or determining a probability of the user being at the location (e.g., the casino).

In some examples, the impression identification system may perform user category-based analysis to (i) label at least some UEs (and/or users) of the plurality of UEs with user categories, and/or (ii) determine category-related impression metrics associated with the POI based upon user category labels. For example, the category-related impression metrics may be indicative of a rate of impressions of users of a user category (e.g., traveler, local, commuter, etc.) per unit of time, a proportion of impressions that are of users corresponding to a user category (e.g., a percentage of impressions that are travelers and/or a percentage of impressions that are commuters and/or local), and/or other metrics. The first report may include the category-related impression metrics.

The first report may provide for a POI agent (e.g., a person and/or software tasked with managing the POI) to more accurately determine compensation (e.g., pricing) for renting the POI for a period of time and/or renting time slots (e.g., advertising slots) of the POI (e.g., an electronic billboard may display a first content item in first timeslots and a second content item in second timeslots). Alternatively, and/or additionally, the first report may be used to more accurately select content to be shown on the POI. For example, the first report may indicate that a relatively larger proportion of impressions of the POI are associated with a first user type (e.g., commuters and/or locals) during a first time of day (e.g., 8:00 AM-10:00 AM) and/or that a relatively larger proportion of impressions of the POI are associated with a second user type (e.g., travelers) during a second time of day (e.g., 12:00 PM-4:00 PM). The POI agent may select first content for the first time of day based upon the first user type (e.g., the first content may include content geared towards residents of the geographical area of the POI) and/or second content for the second time of day based upon the second user type (e.g., the second content may include content related to tourist destinations). A display of the POI (e.g., an electronic display of a billboard) may be controlled to display the first content during the first time of day and/or the second content during the second time of day.

Alternatively, and/or additionally, reports (e.g., the first report) may be generated for a plurality of candidate POI locations. The reports may be used to select one or more POI locations (e.g., highest-performing POI locations with relatively higher impression counts than other candidate POI locations) from the plurality of candidate POI locations. The impression identification system may allocate resources (e.g., manpower, tools, billboard construction materials, etc.) to the one or more (selected) POI locations to construct one or more POIs (e.g., the resources may be allocated to construct one or more billboards at the one or more selected POI locations).

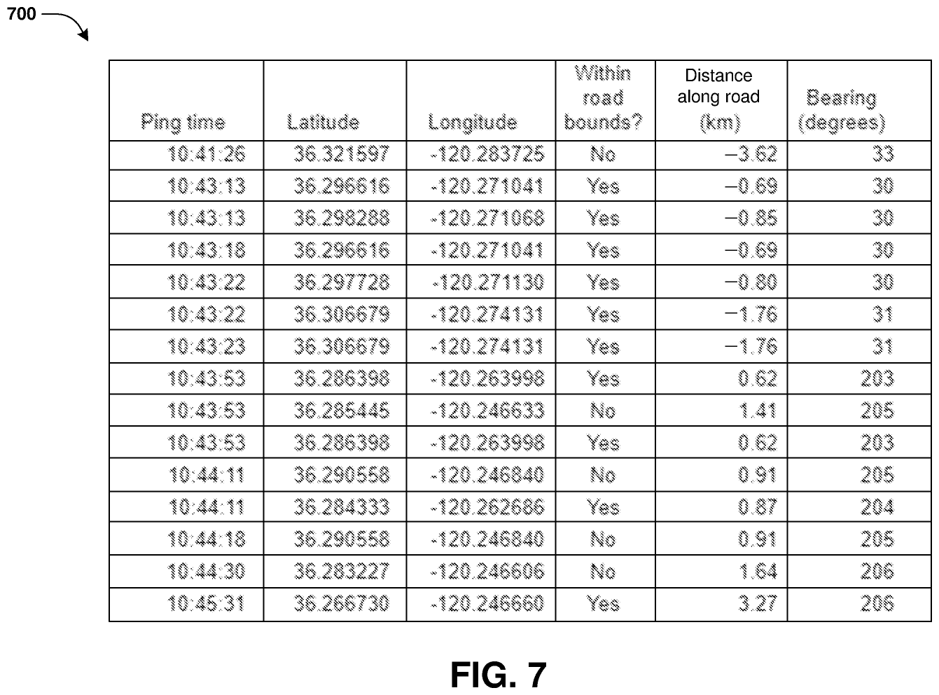

FIG. 7 illustrates an exemplary data structure 700 of a ping sequence for the UE 400 determined to be associated with the impression of the POI. A column labeled “ping time” is the time at which the communication event between the UE 400 and a wireless communication site occurs. The columns labeled “latitude and longitude are at least some of the plurality of locations (e.g., the estimated user position) determined from signals received from the UE 400 (via pings of the ping sequence, for example), in degrees. The column labeled “Within road bounds?” is “Yes” if the UE 400 is within the set of road bounds (defined as 500 meters from the first target road object 410, for example) and “No” if the UE 400 is outside the set of road bounds. “Distance along road” may be a distance (e.g., an absolute distance) between a road object location (e.g., snap to road position) and the POI location 414, in kilometers. The column “bearing” may correspond to the angle between the user snap to road latitude and longitude coordinates (e.g., one or more road object locations) and a bearing vector (e.g., bearing vector 448) of the POI, in degrees. In some examples, the UE 400 is determined to be moving in the viewable direction of the POI (and/or may be determined to span the POI) based upon distance along road values of the “Distance along road” column transitioning from one or more negative values (e.g., −3.62, −0.69, etc.) to one or more positive values (e.g., 0.62, 1.41, etc.).

A first ping from the UE 400 occurs at 10:41:26 approximately 3.62 km from the POI. The UE 400 moves towards the POI until the 7th ping which occurs at 10:43:23. The snap to road position may appear to show the UE 400 moved close to the POI and then moved away, which may be an artifact of an inaccuracy of the location estimate. During the next ping at 10:43:53, the UE 400 is estimated to be on the other side of the POI as indicated by a drastic bearing change and then continues to move away from the POI until the ping at 10:45:31. In this example, other pings have occurred before the first ping and after a last ping of the data structure 700, but they are excluded for clarity. According to these locations and time stamps, the user has moved approximately 7 km in 4 minutes which corresponds to 63 miles per hour, which may be determined to be a reasonable speed for the first target road (e.g., a highway).

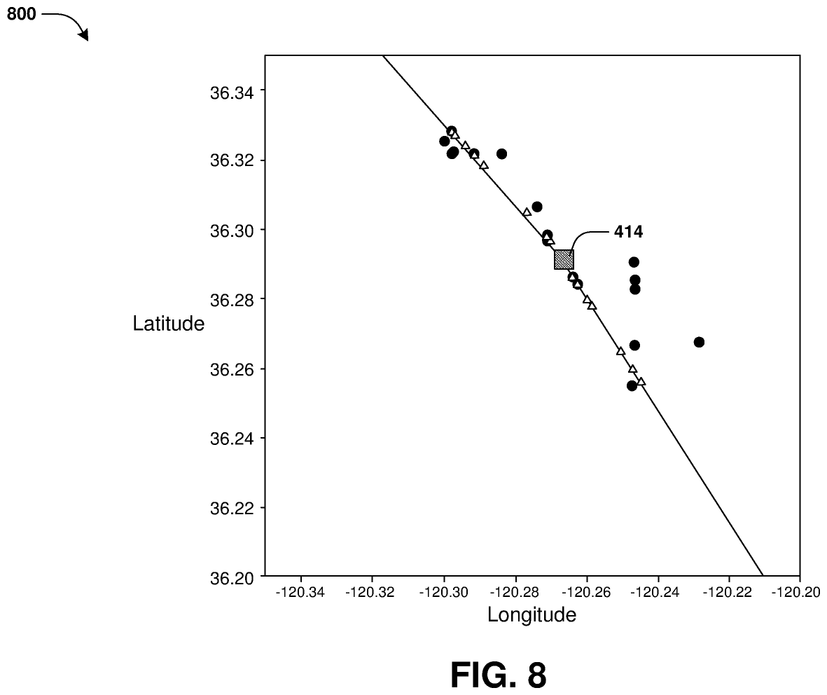

FIG. 8 illustrates a representation 800 of the ping sequence of the exemplary data structure 700. The x axis plots the longitude and the y axis plots the latitude. The POI location 414 is shown as a square. The first target road object 410 is shown as the black line. Ping locations (e.g., the plurality of locations) are shown as black-filled circles. Corresponding snap to road positions (e.g., the set of road object locations) are shown as white-filled triangles. The representation 800 may not indicate a direction of travel (e.g., the first direction of travel) of the UE 400.

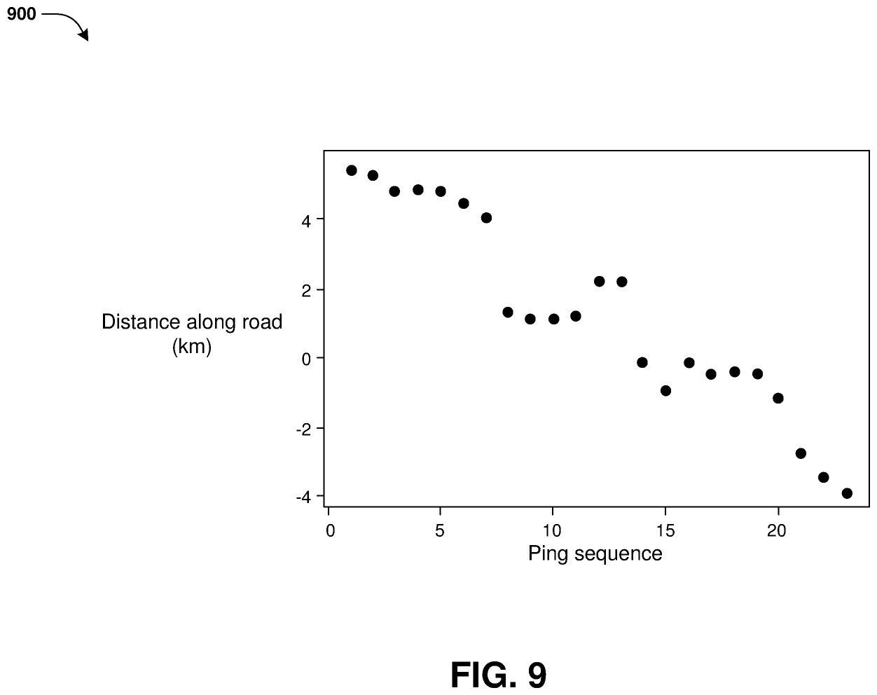

FIG. 9 illustrates an exemplary data structure 900 indicating the direction of travel. An x axis plots the ping sequence from 1 to 23. Alternatively, and/or additionally, a timestamp of a ping may be used for the x axis. The y axis plots the distance from a fixed position from a fixed point on the first target road object 410. Alternatively, and/or additionally, a distance from the POI corrected for the bearing may be used for the y axis. Because the slope of the line is negative, the user would be able to view the POI if the POI is oriented for southbound travelers and would not be able to view the POI if the POI is oriented for northbound travelers.

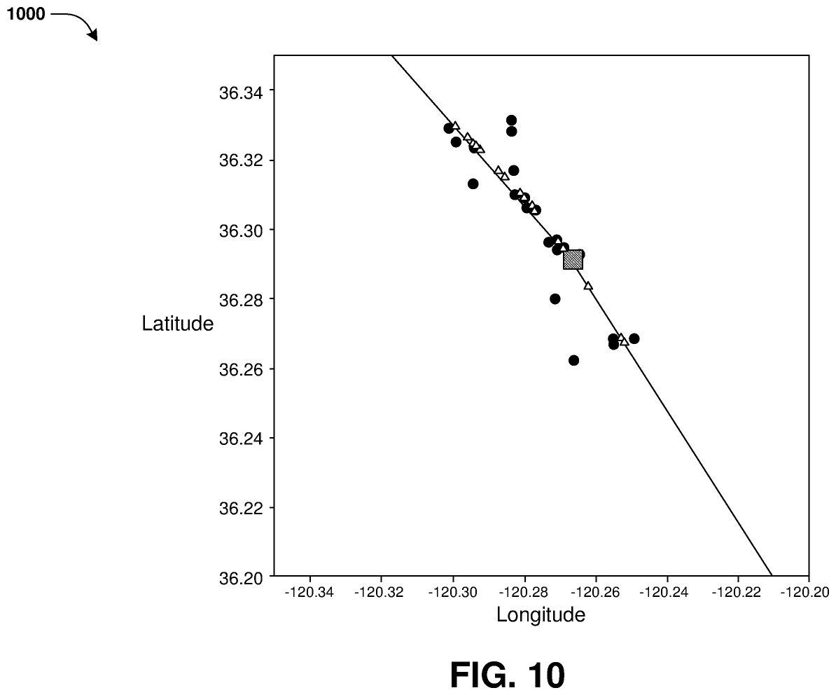

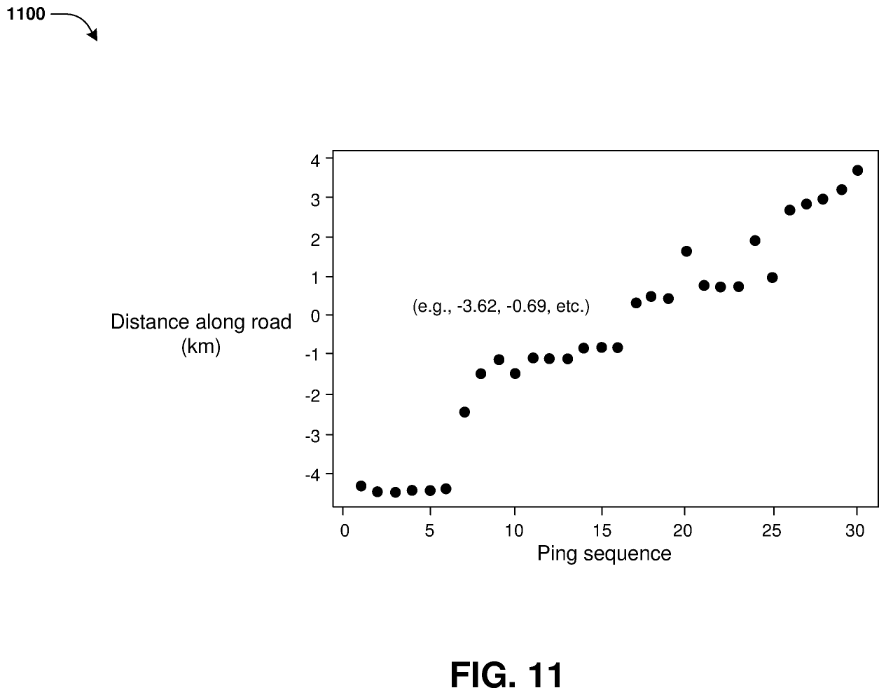

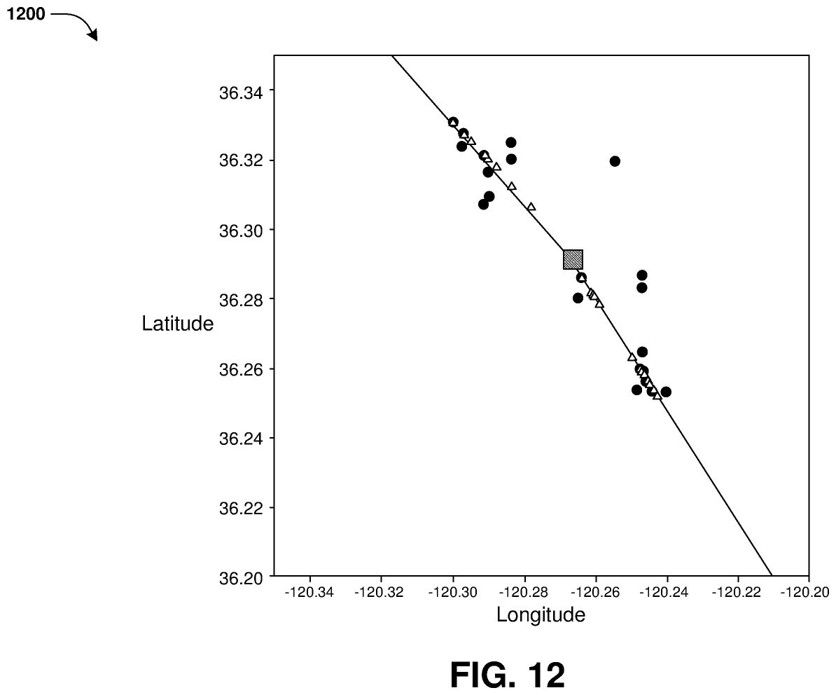

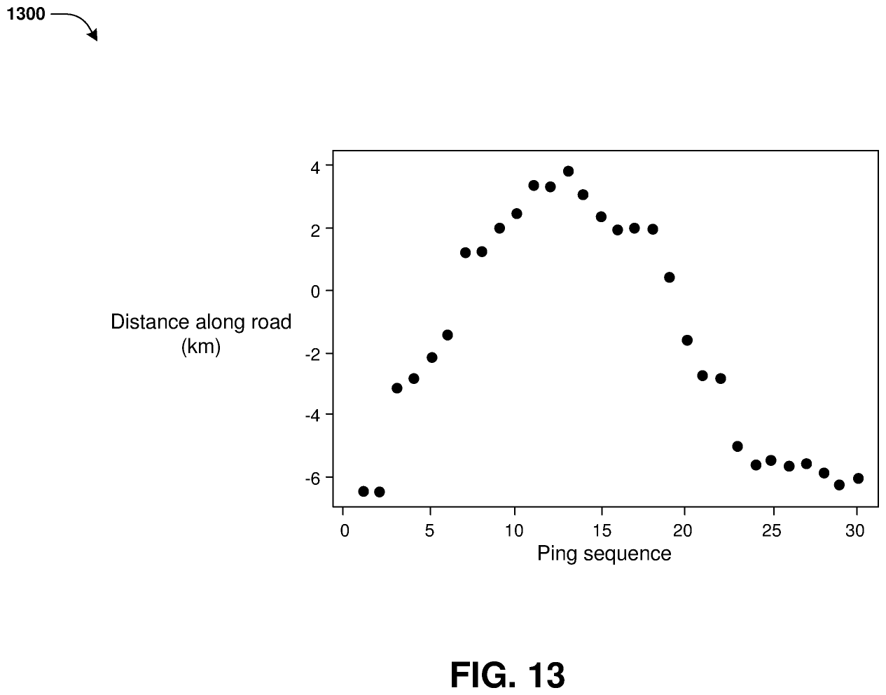

FIG. 10 illustrates a representation 1000 of an exemplary ping sequence. FIG. 11 illustrates an exemplary data structure 1100 (indicating a direction of travel) associated with the representation 1000 of FIG. 10. FIGS. 10 and 11 are similar to FIGS. 8 and 9, respectively, but are for an opposite direction of travel than FIGS. 8 and 9 (e.g., FIGS. 10 and 11 correspond to a northbound traveler whereas FIGS. 8 and 9 correspond to a southbound traveler). FIG. 12 illustrates a representation 1200 of an exemplary ping sequence of a commuter (e.g., the UE 400 may be labeled a commuter). FIG. 13 illustrates an exemplary data structure 1300 (indicating a direction of travel) associated with the representation 1200 of FIG. 12. FIGS. 12 and 13 are similar to FIGS. 8 and 9, respectively, but are for a commuter that travels different (e.g., opposite) directions at different times of the day. For example, the UE 400 may be observed moving northbound in a first sequence of pings and then later southbound in a second sequence of pings.

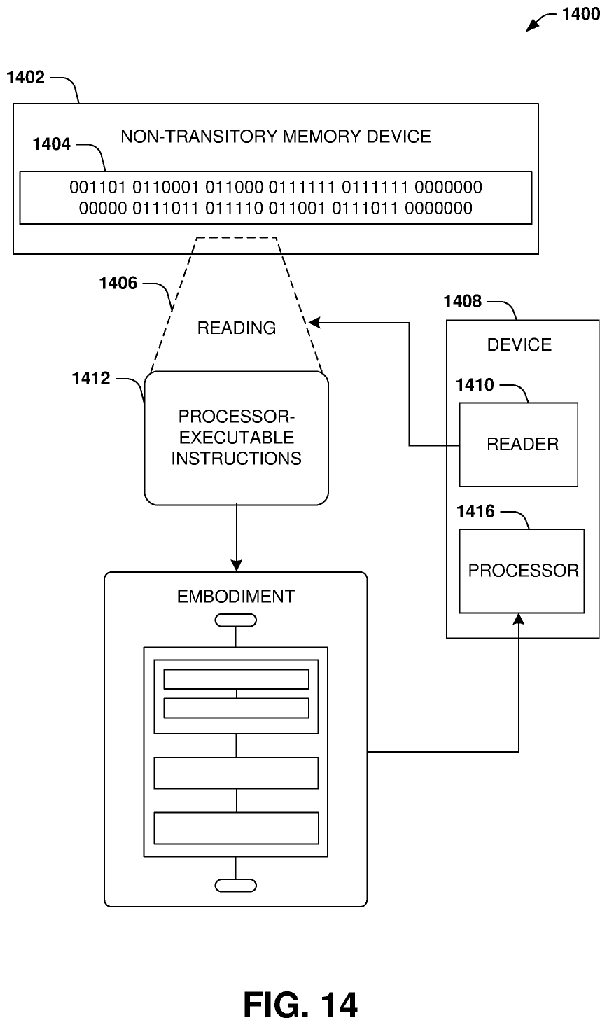

FIG. 14 is an illustration of a scenario 1400 involving an example non-transitory machine-readable medium 1402. The non-transitory machine-readable medium 1402 may comprise processor-executable instructions 1412 that when executed by a processor 1416 cause performance (e.g., by the processor 1416) of at least some of the provisions herein. The non-transitory machine-readable medium 1402 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine-readable medium 1402 stores computer-readable data 1404 that, when subjected to reading 1406 by a reader 1410 of a device 1408 (e.g., a read head of a hard disk drive, or a read operation invoked on a solid-state storage device), express the processor-executable instructions 1412. In some embodiments, the processor-executable instructions 1412, when executed cause performance of operations, such as at least some of the example method 200 of FIG. 2, the example method 300 of FIG. 3, the example method 500 of FIG. 5, and/or the example method 600 of FIG. 6, for example. In some embodiments, the processor-executable instructions 1412 are configured to cause implementation of a system, such as at least some of the example system 151 of FIGS. 1A-1C and/or the example system 401 of FIGS. 4A-4B, for example.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer-readable instructions stored on one or more computer-readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method of identifying a user impression associated with a point of interest (POI), the method comprising:
identifying a first target road of the POI, wherein the POI is viewable from the first target road;
determining a plurality of locations of a User Equipment (UE);
identifying a set of locations, of the plurality of locations, that are within a threshold distance of a road object corresponding to the first target road; and
determining that the UE is associated with the impression based upon the set of locations meeting a threshold amount of locations.

2. The method of claim 1, comprising:
determining, based upon the plurality of locations, a distance of travel of the UE along the first target road, wherein determining that the UE is associated with the impression is based upon the distance of travel meeting a second threshold distance.

3. The method of claim 1, comprising:
determining, based upon the plurality of locations, a direction of travel of the UE along the first target road, wherein determining that the UE is associated with the impression is based upon the direction of travel matching a viewable direction of the POI.

4. The method of claim 1, comprising:
mapping locations of the plurality of locations to a set of road object locations along the road object, wherein the first target road comprises:
a first portion on a first side of the POI; and
a second portion on a second side of the POI; and
determining that the UE is associated with the impression based upon the set of road object locations comprising:
a first road object location in a first portion of the road object corresponding to the first portion of the first target road; and
a second road object location in a second portion of the road object corresponding to the second portion of the first target road.

5. The method of claim 1, comprising:
determining a distance between the road object and a location of the POI; and
determining an angle of an orientation of the road object relative to a bearing of the POI, wherein the first target road is identified based upon:
the distance meeting a second threshold distance; and
the angle meeting a threshold angle.

6. The method of claim 5, comprising:
determining a second distance between a second road object corresponding to a second road and the location of the POI; and
determining that the second road is not a target road of the POI based upon the second distance not meeting the second threshold distance.

7. The method of claim 6, comprising:
determining a second angle of an orientation of a second road object corresponding to a second road relative to the bearing of the POI; and
determining that the second road is not a target road of the POI based upon the second angle not meeting the threshold angle.

8. The method of claim 1, wherein determining the plurality of locations of the UE comprises:
receiving, from one or more wireless communication sites, one or more communication parameters associated with communication between the UE and the one or more wireless communication sites; and
determining, based upon the one or more communication parameters associated with the communication, a location of the UE.

9. The method of claim 1, comprising:
determining, based upon the plurality of locations, a user type associated with the UE.

10. A method of determining a set of target roads of a point of interest (POI), the method comprising:
identifying a first candidate road;
determining a first distance between a first road object corresponding to the first candidate road and a location of the POI;
determining a first angle of a first orientation of the first road object relative to a bearing of the POI; and
including the first candidate road in the set of target roads based upon:
the first distance meeting a threshold distance; and
the first angle meeting a threshold angle.

11. The method of claim 10, comprising:
identifying a second candidate road;
determining a second distance between a second road object corresponding to the second candidate road and the location of the POI; and
not including the second candidate road in the set of target roads based upon the second distance not meeting the threshold distance.

12. The method of claim 10, comprising:
identifying a second candidate road;
determining a second angle of a second orientation of a second road object corresponding to the second candidate road relative to the bearing of the POI; and
not including the second candidate road in the set of target roads based upon the second angle not meeting the threshold angle.

13. The method of claim 10, comprising:
for each road object of a plurality of road objects corresponding to a plurality of roads:
generating a bounding box of the road object; and
determining whether to include a road corresponding to the road object in a set of candidate roads based upon whether the location of the POI is within the bounding box.

14. The method of claim 13, wherein:
one or more first acts for determining whether to include the first candidate road in the set of target roads are performed in response to including the first candidate road in the set of candidate roads based upon the location of the POI being within a first bounding box of the first road object; and
the one or more first acts comprise at least one of:
determining the first distance;
determining the first angle;
comparing the first distance with the threshold distance; or
comparing the first angle with the threshold angle.

15. The method of claim 10, wherein the first road object comprises:
a linestring comprising a plurality of location points of the first candidate road.

16. A non-transitory computer-readable medium storing instructions that when executed perform operations comprising:
identifying a first target road of a point of interest (POI);
determining a plurality of locations of a User Equipment (UE);
identifying a set of locations, of the plurality of locations, that are within a threshold distance of a road object corresponding to the first target road; and
determining that the UE is associated with an impression associated with the POI based upon the set of locations meeting a threshold amount of locations.

17. The non-transitory computer-readable medium of claim 16, the operations comprising:
determining, based upon the plurality of locations, a distance of travel of the UE along the first target road, wherein determining that the UE is associated with the impression is based upon the distance of travel meeting a second threshold distance.

18. The non-transitory computer-readable medium of claim 16, the operations comprising:
determining, based upon the plurality of locations, a direction of travel of the UE along the first target road, wherein determining that the UE is associated with the impression is based upon the direction of travel matching a viewable direction of the POI.

19. The non-transitory computer-readable medium of claim 16, the operations comprising:
mapping locations of the plurality of locations to a set of road object locations along the road object, wherein the first target road comprises:
a first portion on a first side of the POI; and
a second portion on a second side of the POI; and
determining that the UE is associated with the impression based upon the set of road object locations comprising:
a first road object location in a first portion of the road object corresponding to the first portion of the first target road; and
a second road object location in a second portion of the road object corresponding to the second portion of the first target road.

20. The non-transitory computer-readable medium of claim 16, the operations comprising:
determining a distance between the road object and a location of the POI; and
determining an angle of an orientation of the road object relative to a bearing of the POI, wherein the first target road is identified based upon:
the distance meeting a second threshold distance; and
the angle meeting a threshold angle.
